(19) United States
(12) Patent Application Publication
(10) Pub. No.: US 2007/0017641 A1
(43) Pub. Date: Jan. 25, 2007

(54) Heat imprinting machine with separate work piece support

(76) Inventor: Dan Kenney, Kirkland, WA (US)

Correspondence Address: BARNARD INTELLECTUAL PROPERTY LAW, INC., P.O. BOX 58888, SEATTLE, WA, 98138-1888, US

(21) Appl. No.: 11/378,156

(22) Filed: Mar. 17, 2006

Related U.S. Application Data
(63) Continuation-in-part of application No. 10/790,433, filed on Feb. 27, 2004, now abandoned.

(51) Int. Cl. B30B 15/34

(52) U.S. Cl. 156/583.1; 156/583.8

(57) ABSTRACT

A handle (22) is moved between a first position (FIG. 1) and a second position (FIG. 2). When the handle (22) is in its first position a mechanism between the handle (22) and an upper platen (20) raises the upper platen into a raised position. In this position it is above a work piece mounting board (26) which in turn is spaced above a lower platen (18). Movement of the handle from its first position (FIG. 1) into its second position (FIG. 2) causes the mechanism to move the upper platen (20) downwardly against a work piece on the work piece supporting board (26). As the upper platen (20) moves downwardly, it moves the work piece and the work piece supporting board (26) downwardly against the lower platen (18). An adjustment mechanism (122, 86, 92) provides for a way of compensating for different thicknesses in the work piece that is on the work piece supporting board (26). A four-bar linkage (50, 52, 54, 56) mounts the work piece supporting board (26) for vertical up and down movement. A spring (60) biases the mounting board (26) in a raised position spaced above the lower platen (18).

### RELATED APPLICATION

This is a continuation-in-part of my co-pending application Ser. No. 10/790,433, filed Feb. 27, 2004, and entitled Heat Imprinting Machine with Separate Work Piece Support.

### TECHNICAL FIELD

This invention relates to a heat imprinting machine having a heated upper platen movable towards and away from a lower platen. More particularly, it relates to the provision of such machine with a work piece mounting board between the two platens, for supporting the article to be printed, and an improved mechanism for moving the upper platen up and down.

### BACKGROUND OF THE INVENTION

It is well known to apply indica and decorative matter onto shirts, towels, hats, visors, and other articles (“work piece”), by use of a heat transfer process. A layer of thermal-set material is applied to one side of a generally planar sheet, termed a “transfer.” Typically, the work piece is positioned on the lower platen of a press. The transfer is set down on the work piece with its thermal-set material in contact with the work piece. Then, a heated upper platen is lowered onto the transfer and pressure and heat are applied to the transfer. The combination of heat and pressure causes adhesion of the transfer to the substrate. Known heat transfer machines in the patent literature are disclosed by the following U.S. Pat. No. 3,119,728, issued Jan. 28, 1964 to Melvin N. Janapol; U.S. Pat. No. 4,243,470, granted Jan. 6, 1981 to Shigehiko Higashiguchi; U.S. Pat. No. 4,386,993, granted Jun. 7, 1983, to Mototsugu Matsuo; U.S. Pat. No. 4,963,208, granted Oct. 16, 1990 to Charles W. Muncy and Peter Stulberger; U.S. Pat. No. 5,167,750, granted Dec. 1, 1992 to David A. Meyers; and U.S. Pat. No. 6,151,814, granted Nov. 28, 2000 to Steve M. Raio, John J. Boyer, Jesus Mendoza and Harry Springer, III. A common feature of these machines is that the work piece is supported on the lower platen.

There is a need for an improved heat transfer press that is easy and quick to operate. It is a primary object of the present invention to fill this need. There is also a need for an improved mechanism for moving the upper platen up and down in response to the swinging of a handle between first and second positions. It is a further object of the invention to fill this need.

### BRIEF SUMMARY OF THE INVENTION

According to an aspect of the invention, a heat imprinting machine is provided that comprises a frame including a base, a support post extending upwardly from the base, and a horizontal support arm connected to the post and spaced above the base. A lower platen is connected to the frame below the support arm. An upper platen is supported on the support arm for movement towards and away from the lower platen. A carrier is mounted on the post and is movable up and down. A work piece supporting board is positioned between the upper and lower platens. This board has an end portion that is connected to the carrier. A control lever is provided that is connected to the horizontal support arm and the upper platen. The control lever is movable between a first position in which it moves the platen downwardly against the work piece supporting board, causing the work piece supporting board to move downwardly towards the lower platen, and a second position in which it moves the upward platen upwardly away from the work piece supporting board, allowing movement of the work piece supporting board upwardly from the lower platen.

The machine preferably includes a spring that is positioned bias the work piece supporting board in an upward position, away from the lower platen. Operation of the control lever to move the upper platen downwardly against the work piece supporting board will move the work piece supporting board downwardly against the spring force and towards the lower platen.

In preferred form, there is a detachable connection between the end portion of the work piece support and the carrier.

### BRIEF DESCRIPTION OF THE SEVERAL VIEWS OF THE DRAWINGS

Like reference numerals are used to designate like parts throughout the several views of the drawing, and:

FIG. 1 is a side elevational view of a heat imprinting machine, showing a control lever and an upper platen in raised positions, and showing a work piece supporting board positioned between the upper and lower platens;

FIG. 2 is a view like FIG. 1, but showing the control lever and the upper platen moved into lowered positions, in which the upper platen contacts the work piece supporting board and the work piece supporting board contacts the lower platen;

FIG. 3 is a fragmentary pictorial view of the control handle and a mechanism provided for moving the upper platen up and down in response to a swinging movement of the handle, such view showing the handle in the same position as shown by FIG. 1;

FIG. 4 is a view like FIG. 3 but showing the handle moved down into the same position that it is in FIG. 2;

FIG. 5 is a fragmentary side elevational view showing the connection at one end of the work supporting support board to a carrier that is connected for up and down movement on a support post that is connected to and extends upwardly from the base of the machine, such view showing the upper and lower platens and the work piece supporting board in the position shown by FIG. 2;

FIG. 6 is a view like FIG. 5 but showing the upper and lower platens and the work piece supporting board in the positions shown by FIG. 1;

FIG. 7 is a pictorial view of the heat imprinting machine shown by FIGS. 1-6, showing the handle and the upper platen in raised positions and further showing the support arm assembly for the upper platen swung sideways into a position to one side of the work supporting board, so as to provide access to the work supporting board;

FIG. 8 is an exploded pictorial view of the work piece supporting board and the carrier for such board that is mounted on the support post;

FIG. 8A is an enlarged portion of FIG. 8;

FIG. 9 is a fragmentary sectional view of the region shown by FIG. 3, showing a modified construction of the vertical post that extends up and down when the handle is moved, such views showing a second way of adjusting the effective length of the post between its connection to a lever connected to the handle and the upper platen;

FIG. 10 is a fragmentary side elevational view of the heat imprinting machine in the position shown by FIG. 2; and

FIG. 11 is a view like FIG. 10, but showing the parts in the position shown by FIG. 1.

### DETAILED DESCRIPTION OF THE EMBODIMENTS OF THE INVENTION

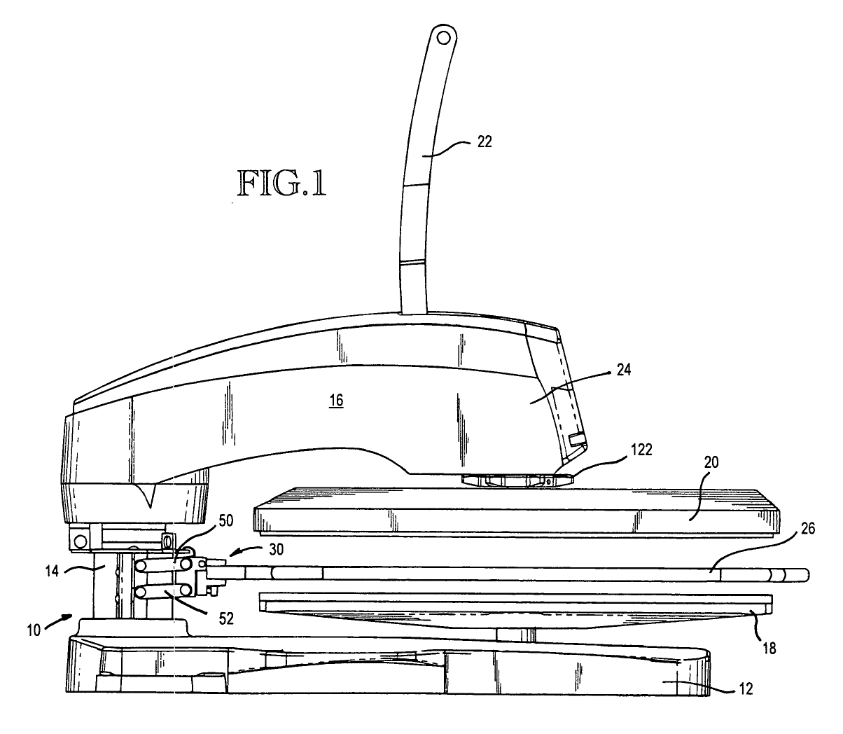

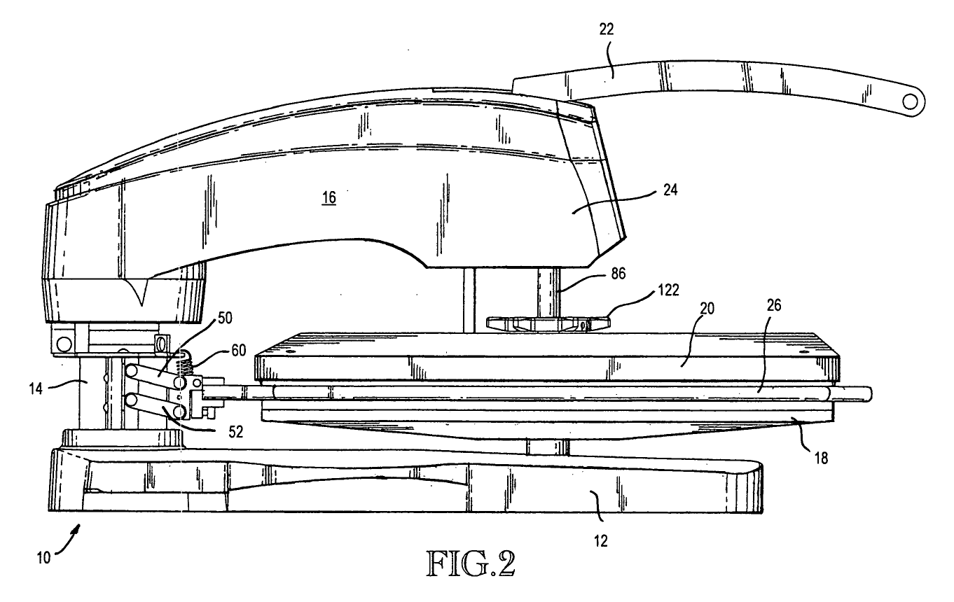

The following is a description of embodiments of the invention, including the preferred embodiment. Referring to FIGS. 1 and 2, the illustrated embodiment comprises a frame 10 having a base 12, a support post 14 and a horizontal support arm 16. The support post 14 extends upwardly from the base 12. The horizontal support arm 16 is connected to the upper end of the support post and is spaced above the base 12. A lower platen 18 is connected to the frame 10 below the support arm 16. An upper platen 20 is connected to the frame 10 below the support arm 16. A swing handle 22 is provided for use in moving the platen 20 up and down. When the handle 22 is up (FIG. 1), the upper platen 20 is spaced upwardly above the lower platen 18. When the handle 22 is moved downwardly (FIG. 2), a mechanism within the support arm 16 operates to move the upper platen downwardly towards the lower platen 18. A preferred embodiment of this invention is described below.

According to an aspect of the invention, a work piece support 26 is provided for insertion between the platens 18, 20. A particular work piece support 26 that is illustrated may be for a T-shirt or sweatshirt. The particular construction of the work piece support 26 is not an essential part of the invention. The present invention is not limited to the illustrated support or even to a support for a shirt. The support may be for many other items upon which one might wish to print indicia or artwork.

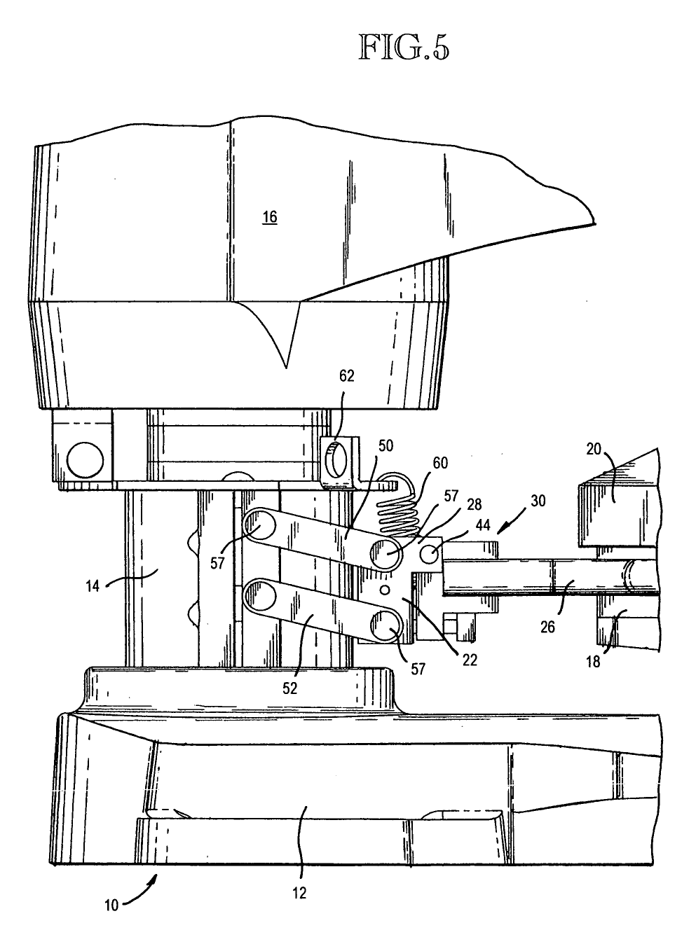

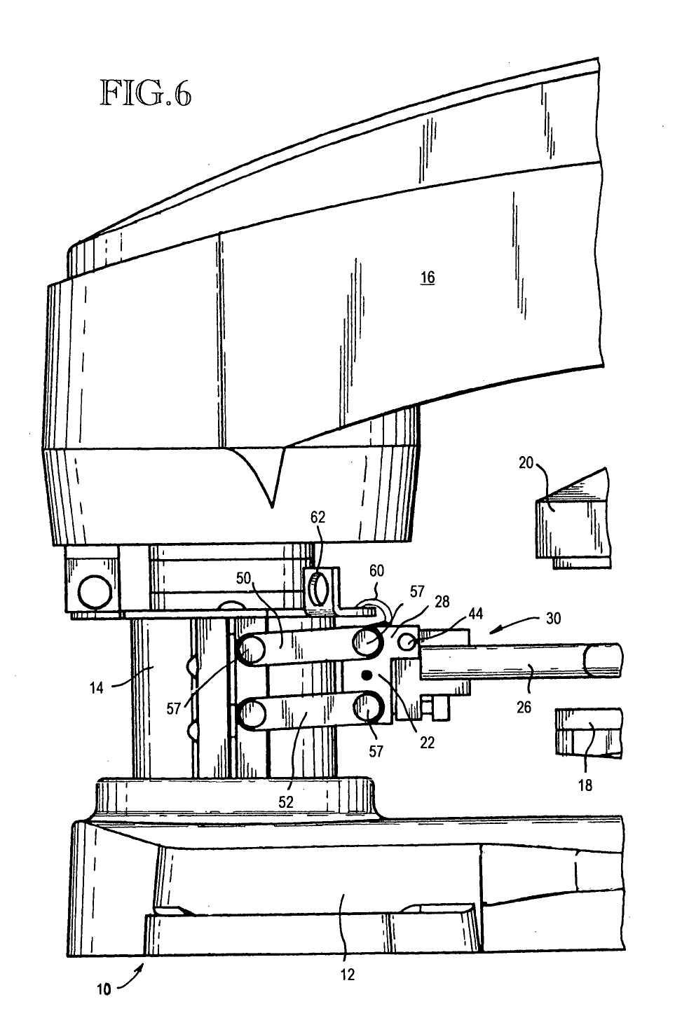

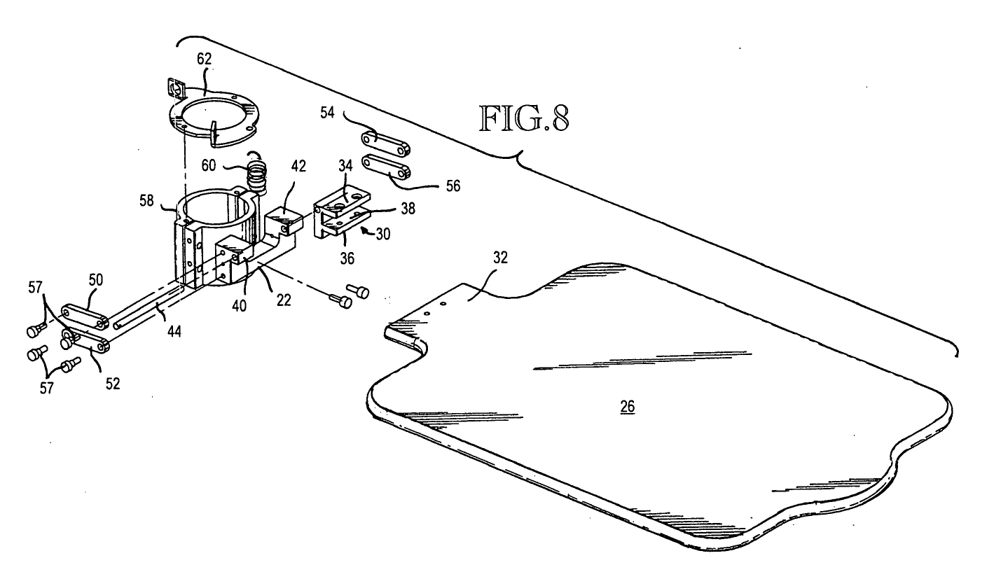

The work piece support 26, whatever be its character, is preferably detachably connected to a carrier member 28 that is mounted for up and down movement along side the post 14 (see FIGS. 5, 6 and 8). Referring to FIGS. 8 and 8A, a yolk 30 is connected to an end portion 32 of the work piece support board 26. Upper and lower legs 34, 36 of the yolk 30 are spaced apart to provide a space 38 in which the end portion 32 of the work piece support board 26 is received. Then, screws or other fasteners (not shown) are inserted vertically through openings 33 in the legs 34, 36 and the end piece 32, for connecting the work piece mounting board 26 to the yolk 30 (FIG. 8A). Yolk 30 is then positioned between side members 40, 42 on the carrier 28, and a pin 44 is inserted through openings 46 in the side portions 40, 42 and opening 48 in the yolk 30, for connecting the yolk 30 to the carrier 28. Links 50, 52, 54 and 56 are each pivotally connected at one end to a mounting sleeve 58 and at an opposite end to the carrier 22. Screw fasteners 57 are used for pivotally connecting the ends of the links 50, 52, 54, 56 to the sleeve 58 and the carrier 22. This construction provides a four-bar linkage on each side of the carrier 28.

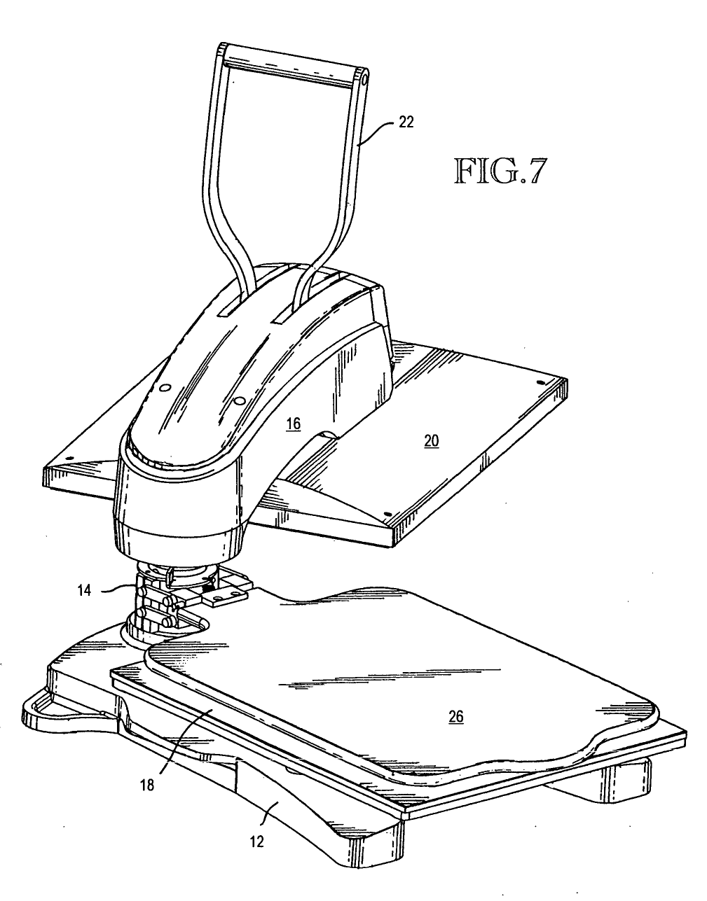

The mounting sleeve 58 is composed of two semi-cylindrical sections, each having flanges along their side edges. The sleeve sections are placed on the post 14 and screws (not shown) are used to connect the flanges together, for connecting the sleeve parts to the post 14. In this embodiment, a spring 60 is interconnected between the carrier 28 and a ring 62 that fits around the post 14 on top of the split sleeve 58, and the carrier 22. The spring 60 biases the carrier 28 and the work piece support member 26 into the position shown by FIG. 1. FIG. 7 shows that the upper assembly, including the support arm 16, the upper platen 30, the handle 22, etc. are rotatable around the vertical axis of the post 14, for moving them between a first position above the work piece supporting board 26 and the lower assembly including the base 12 and the lower platen 18, and a second position in which they are swung to one side of the board and lower platen 18, so as to provide worker access to the work piece supporting board 26. The upper assembly may be mounted for this pivotable movement in any suitable way.

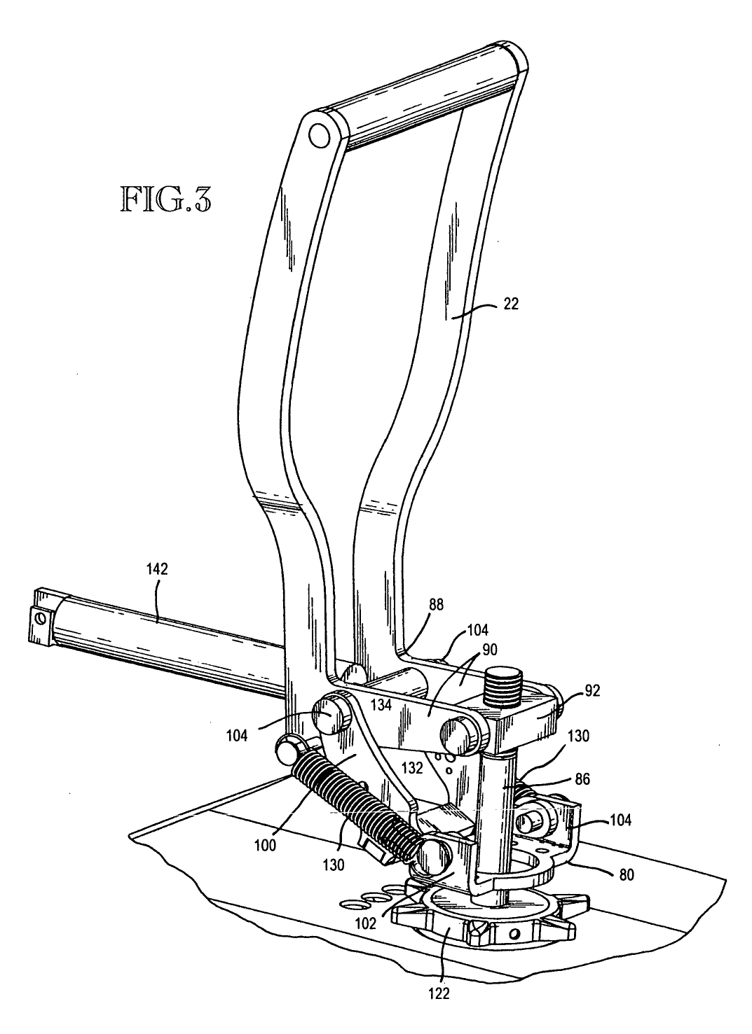

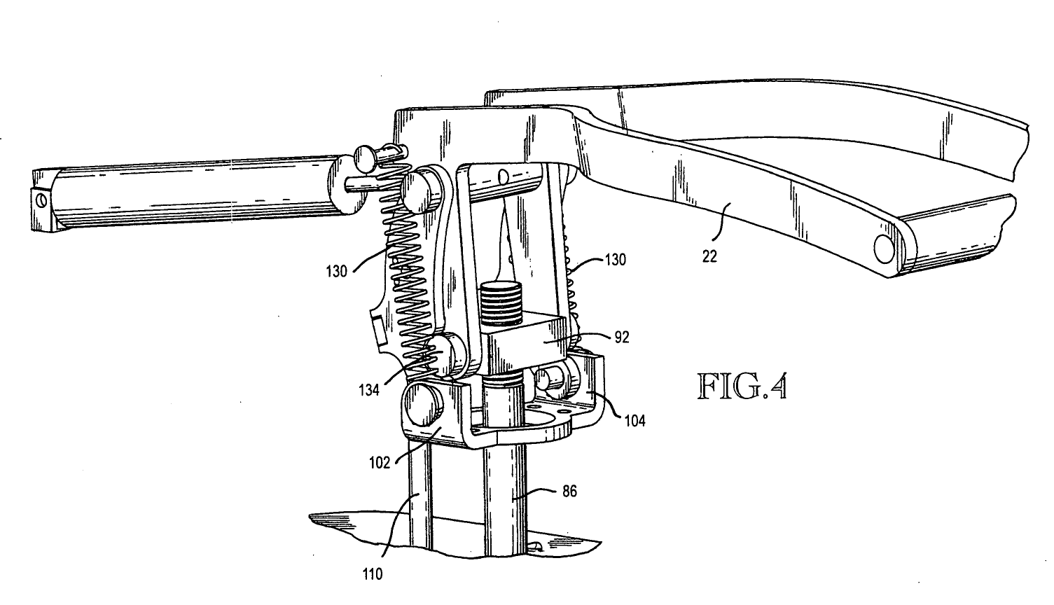

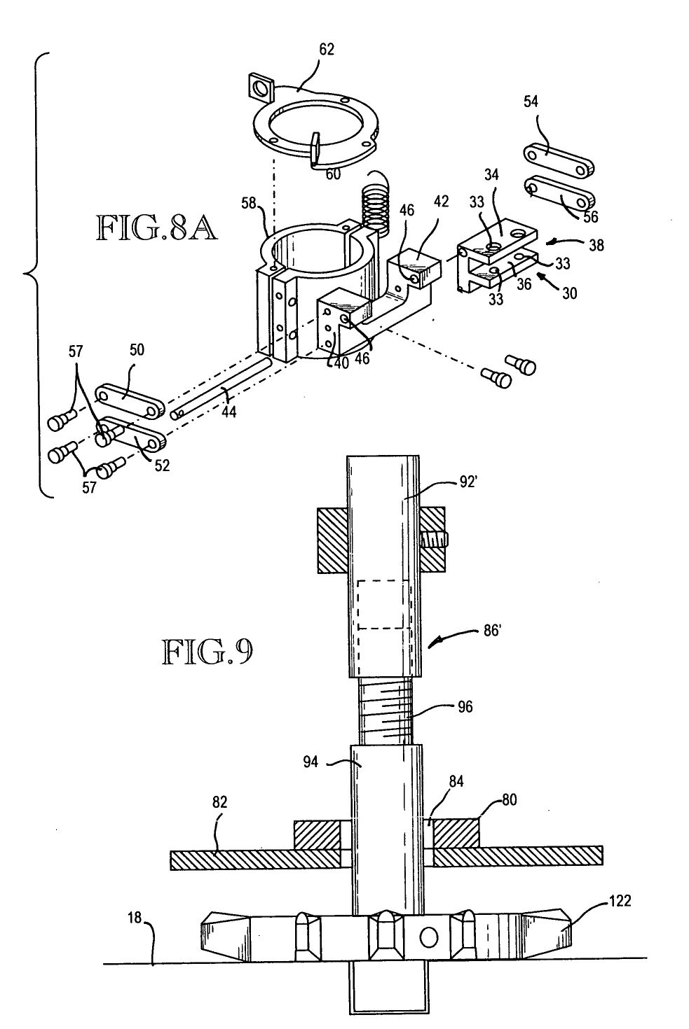

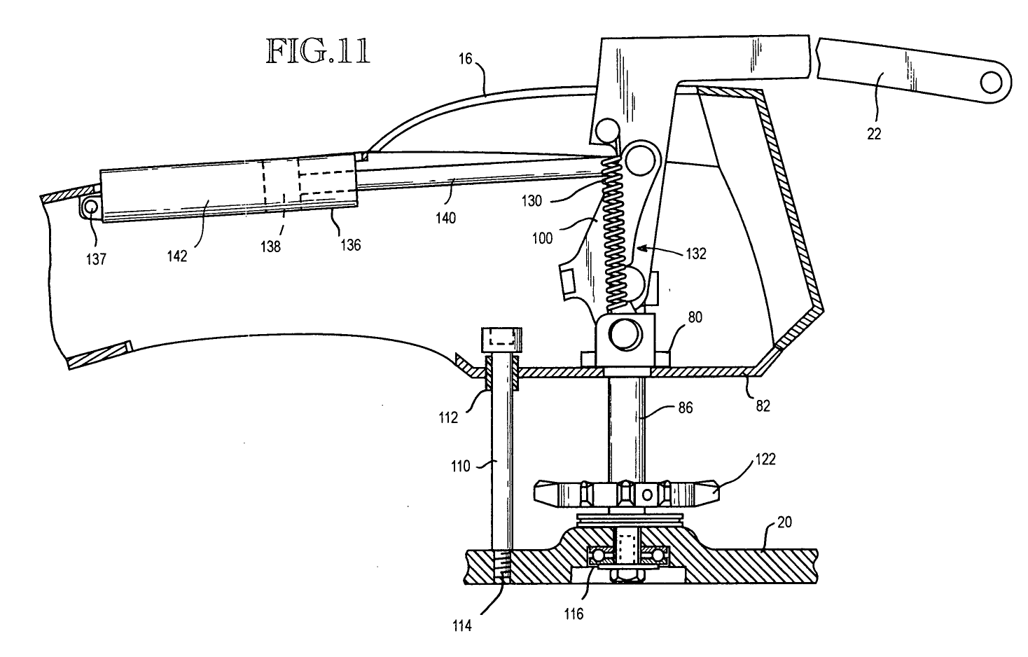

The illustrated embodiment includes a mechanism for moving the upper platen 20 up and down in response to the swinging movement of the handle 22. This mechanism is best shown in FIGS. 3, 4, 9, 10 and 11. Referring to FIGS. 11 and 12, a fixed guide ring 80 is attached to the bottom wall 82 of the support arm 16. This ring 80 includes a guide opening 84 (FIG. 9) through which a vertical rod 86, 86′ extends. The handle 22 is connected to a control lever 88 having a first arm portion 90 with a first end that is pivotally connected to the upper end of the post 86. As shown in FIGS. 3 and 4, the upper end of the post 86 may be threaded and may be screwed into a threaded opening in a nut 92. The first arm portion 90 of the lever 88 is shown to be pivotally connected to the nut 92. This provides a pivotable connection between the first end of the arm portion 90 and the post 86 which includes the nut 92. FIG. 9 shows a modified construction in which the nut 92′ is an upper portion of the post 86′. The post 86′ is of two-piece construction. Its upper portion 92 is connected to its lower portion 94 by a threaded connection 96. In this embodiment, the upper portion 92′ of the post 86 is a nut like the nut 92 in the first embodiment. In both embodiments, the post below the threaded connection is rotatable for the purpose of lengthening or shortening the effective length of the post 86, 86′.

A second lever 100 has a first end that is pivotally connected to ears 102, 104 on the guide ring 80. Lever 100 has a second end that is pivotally connected to the second end of the first lever 90, at location 104. The handle 22 projects upwardly from the second end of the first level 104, in the manner shown by FIGS. 3, 4, 10 and 11, in particular. As can be seen, when the handle is in the position of FIGS. 1, 3 and 10, the lever 90 is in a substantially horizontal position and the post 86, 86′ is a raised position. Rotation of the handle 22 downwardly, into the position shown by FIGS. 2, 4 and 11, pivots the first lever 104 downwardly, about its pivotal connection to the second lever 100, this moves nut 92, 92′ downwardly, moving with it the post 86, 86′. The construction of the linkage, and the provision of the pivotal connections between the levers and between the first lever 90 and the nut 92, 92′ and the second lever 100 and the guide ring 80, results in the movement of the post 86, 86′ being a vertical up and down movement.

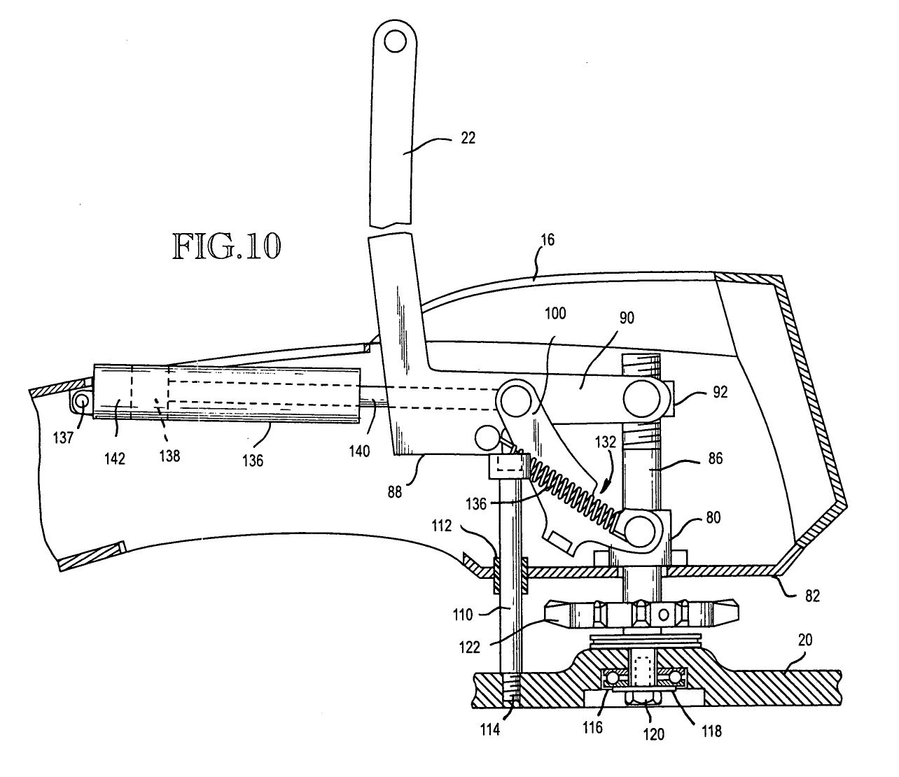

The lower end of the post 86, 86′ is suitably connected to the upper platen 20. In the illustrated embodiment, a guide pin 110 is positioned radially outwardly from the post 86, 86′. It has an upper end portion that slides in a bushing 112 that is carried by the lower wall 82 of the support arm 16. The lower end of the guide pin 110 is connected to the upper platen 20, such as by a threaded connection 114 (FIGS. 10 and 11). The guide pin 110 prevents the upper platen 20 from rotating in position relative to the support arm 16, about the axis of the post 86. In the illustrated embodiment, the lower end of the post 86, 86′ is connected to the upper platen 20 in a manner that will allow the post 86, 86′ to rotate relative to the upper platen 20. FIGS. 10 and 11 show a bearing 116 carried by the upper platen 20. The lower portion of the post 86 extends through this bearing and a thrust washer 118 is positioned below the bearing 116. A bolt 120 or the like extends through the thrust washer and connects to the lower end portion of the post 86.

A rotatable knob 122 is connected to the lower portion of the post 86, between the bottom wall 82 of the support arm 16 and the upper platen 20. Knob 122 can be easily grasped and rotated. When it is rotated in one direction, it shortens the effective length of the post 86, 86′. When rotated in the opposite direction it lengthens the effective length of the post 86, 86′. That is, rotation of the knob 122 will rotate the portion of the post 86, 86′ that is below the threaded connection, within the nut 92, 92′. Movement of the post upwardly into the threaded nut shortens the effective length of the post 86, 86′. Movement of the threaded connection downwardly through the threaded nut 92, 92′ effectively lengthens the length of the post 86, 86′.

One or more springs 130 are provided to extend between the guide ring ears 102, 104 and the elbow of the handle/lever 22, 90 assembly. The spring or springs 130 are tension springs. As shown by FIGS. 4 and 11, when the handle 22 is in its down position, the springs 130 are lengthened, storing energy in them. When the handle is in the position shown by FIGS. 3 and 10, the springs 130 are shortened. The lever 100 includes a notch 132 on each of its sides. When the handle/lever assembly 22, 90 is in its down position, shown by FIGS. 4 and 11, the lever 100 is swung into a position in which the notches 132 engage pins 134. The pins 134 are at the ends of the pivotal connections between the first ends of the lever 100 and the guide ring 80. This is best shown by FIG. 11.

An air cylinder 136 may be interconnected between a location 138 on the support arm 16 and the pivotal connection where the first lever 90 is pivotally connected to the second lever 100. Movement of the handle 22 from the position shown by FIGS. 3 and 10 into the positions shown by FIGS. 4 and 11 lengthens the cylinder 136. This lengthening of the dash pot 136 moves a piston 138 and its piston rod 140 out from cylinder rod 142. At the same time air is delivered into the chamber between the piston 138 and the closed end of the cylinder 142. This body of air functions to hold the handle/lever assembly 22, 90 into the positions had shown by FIGS. 4 and 11, for example. The air pressure is released so that the handle can be moved back from the position shown by FIGS. 4 and 11 into the positions shown by FIGS. 3 and 10. In response to such handle movement, the piston 138 will move towards the closed end of the cylinder 142, shortening the air chamber and pushing air out from it. At the same times air maybe introduced into the chamber that is formed at the rod end of the piston 138. When the handle is in the position shown by FIGS. 3 and 10, the air in the rod and chamber serves to hold the handle/lever assembly 22, 90 in the position shown by FIGS. 3 and 10. In another embodiment, the air cylinder can be used for moving the lever 100 between its two positions, shown by FIGS. 10 and 11.

Referring to FIG. 1, when the handle 22 is in its up position, the upper platen 20 is raised above the work piece supporting board 26. At the same time, the spring or springs 60 raising the carrier 22 and the work piece supporting board 26 into a position spaced above the lower platen 18. Movement of the handle 22 from the position shown by FIG. 1 into the position shown by FIG. 2 operates the mechanism shown by FIGS. 3, 4, 10 and 11 to move the upper platen 20 downwardly. The upper platen first moves against a work piece (not shown) that is on the work piece supporting board 26. As it moves downwardly further, the upper platen 22 moves with it the work piece and the work piece supporting board 26. Movement continues until the work piece supporting board 26 is against the lower platen 18. The four-bar linkage, including bars 50, 52, 54, 56, causes the work piece supporting board 26 to move vertically up and down relatively along the post 12. Work piece supporting board 26 moves vertically between its down position, against lower platen 18, and its “up” position, established by the spring or springs 60. The adjustment mechanism, including control knob 102, provides a way of properly positioning the upper platen on the work piece and the work piece supporting board 26, when the work piece supporting board is down on the lower platen 18. The adjustment is made to compensate for the thickness of the particular work piece that is on the work piece supporting board 26.

The illustrated embodiments are only examples of the present invention and, therefore, are non-limitive. It is to be understood that many changes in the particular structure, materials and features of the invention may be made without departing from the spirit and scope of the invention. Therefore, it is my intention that my patent rights not be limited by the particular embodiments that are illustrated and described herein, but rather are to be determined by the following claims, interpreted according to accepted doctrines of patent claim construction, including use of the doctrine of equivalents.

What is claimed is:

1. Mechanism for moving a platen up and down, comprising:
a fixed tubular guide including an opening for receiving an elongated rod;
an elongated rod extending through said guide, said rod having a lower end that is attached to a platen and an upper end that projects upwardly from the guide;
a first lever having a first end pivotally connected to an upper portion of the rod and a second end;
a handle connected to the second end of the lever and projecting upwardly from it;
a second lever having a first end that is pivotally attached to the guide and a second end that is pivotally attached to the second lever at a location spaced from the first end of the first lever;
said first lever being pivotally connected to the rod and said second lever being pivotally connected to the guide member and the first lever about axes that are parallel to each other;
whereby the handle can be moved from a first position for rotating the second end of the first level about the pivotal connection of its first end to the rod, causing the pivotal connection of the second end of the second lever to the first level to swing upwardly along an arc and then further causing the rod to move downwardly, through the guide and moving with it the platen.

2. Mechanism according to claim 1, wherein the rod length below the connection of the rod to the first end of the first level is adjustable.

3. The mechanism of claim 2, wherein a nut is connected to the first end of the first level, said nut including an internally threaded opening, and said rod having a threaded upper end portion that screws into the threaded opening of the nut.

4. The mechanism of claim 2, wherein the rod has upper and lower end portions, the upper end portion is connected to the first end of the first lever, and there is a threaded connection between the upper and lower end portions, and said lower end portion is rotatable relative to the upper end portion, for changing the length of the rod below where it is connected to the first end of the first lever.

5. A heat imprinting machine, comprising:
a frame including a base, a support post extending upwardly from the base, and a horizontal support arm connected to the post and spaced above the base;
a lower platen connected to said frame below the support arm;
an upper platen supported on the support arm fro movement towards and away from the lower platen;
a carrier mounted on the post, said carrier being movable up and down;
a work piece supporting board positioned between the upper and lower platens, said board having an end portion connected to the carrier; and
a control lever connected to the horizontal support arm and the upper platen, and movable between a first position in which it moves the platen downwardly against the work piece supporting board, causing the work piece supporting board to move downwardly towards the lower platen, and a second position in which it moves the upper platen upwardly away from the work piece supporting board, allowing movement of the work piece supporting board upwardly from the lower platen.

6. The machine of claim 5, comprising a spring biasing the work piece supporting board in an upward position, away from the lower platen, whereby operation of the control lever to move the upper platen downwardly against the work piece supporting board will move the work piece supporting board downwardly against the spring force and towards the lower platen.

7. The machine of claim 5, comprising a detachable connection between said end portion of the work piece supporting board and the carrier.

8. The machine of claim 5, wherein the horizontal support arm includes a fixed guide ring having a guide opening, a rod extending through the guide opening and having a lower end that is connected to the upper platen below the horizontal support arm, and an upper end, said control lever having a first arm portion with a first end that is pivotally connected to the upper end of the post, and a second end, an independent lever arm having a first end that pivotally connected to the guide ring and a second end that is pivotally connected to the second end of the first lever arm, and said lever arm including a handle portion that projects upwardly from the second end of the first lever arm, whereby rotation of the handle in one direction will cause the first end of the first lever arm to rotate about the first pivot axis and will cause the second end of the first pivot arm to swing along an arc, and will cause the second end of the second lever arm to swing along the same arc, and the first end of the first lever arm will push the post downwardly through the guide ring and will move the upper platen downwardly towards the lower platen.

9. The heat imprinting machine of claim 5, comprising a four-bar linkage interconnected between the post and the carrier, for permitting and causing the carrier and the work piece supporting board to move up and down.

10. The heat imprinting machine of claim 9, comprising at least one spring for biasing the carrier in a relatively upper position.
